(19) United States
(12) Patent Application Publication
(10) Pub. No.: US 2014/0356652 A1
(43) Pub. Date: Dec. 4, 2014

(54) BATTERY THERMAL MANAGEMENT SYSTEM FOR ELECTRIFIED VEHICLE

(71) Applicant: Ford Global Technologies, LLC, Dearborn, MI (US)

(72) Inventors: Bhaskara Rao Boddakayala, Canton, MI (US); Bruce Carvell Blakemore, Plymouth, MI (US); Clay Wesley Maranville, Ypsilanti, MI (US); Ray C. Siciak, Ann Arbor, MI (US)

(21) Appl. No.: 13/909,126

(22) Filed: Jun. 4, 2013

(51) Int. Cl. H01M 10/613

(52) U.S. Cl. CPC H01M 10/5004
USPC 429/50; 429/120; 429/62

(57) ABSTRACT

A battery module according to an exemplary aspect of the present disclosure includes, among other things, a battery cell, a plate adjacent to the battery cell and a heat pipe attached to the plate and containing a first heat transfer medium. A manifold is connected to the heat pipe and configured to receive a second heat transfer medium that exchanges heat with the first heat transfer medium.

### TECHNICAL FIELD

This disclosure relates to an electrified vehicle, and more particularly, but not exclusively, to a battery module for an electrified vehicle.

### BACKGROUND

Hybrid electric vehicles (HEV's), plug-in hybrid electric vehicles (PHEV's), battery electric vehicles (BEV's) and other known electrified vehicles differ from conventional motor vehicles in that they employ one or more electric machines in addition to an internal combustion engine to drive the vehicle. Electrified vehicles may also be equipped with a battery that stores electrical power for powering the electric machines. In some vehicles, an electric machine may also be employed as a generator that is powered by the internal combustion engine in order to generate electrical power to charge the battery.

The battery of an electrified vehicle is typically constructed from one or more battery modules that include a plurality of battery cells. In certain conditions, such as during charging and discharging operations or extreme ambient conditions, heat may be generated in the battery cells. This heat may need removed to improve battery cell capacity and life.

### SUMMARY

A battery module according to an exemplary aspect of the present disclosure includes, among other things, a battery cell, a plate adjacent to the battery cell and a heat pipe attached to the plate and containing a first heat transfer medium. A manifold is connected to the heat pipe and configured to receive a second heat transfer medium that exchanges heat with the first heat transfer medium.

In a further non-limiting embodiment of the foregoing battery module, a fin structure is attached to a bottom of the battery cell.

In a further non-limiting embodiment of either of the foregoing battery modules, the battery modules comprise a plurality of battery cells and a plurality of plates, at least one of the plurality of plates interspersed between adjacent battery cells of the plurality of battery cells.

In a further non-limiting embodiment of any of the foregoing battery modules, the manifold is hollow and the second heat transfer medium is communicated inside a hollow opening of the manifold.

In a further non-limiting embodiment of any of the foregoing battery modules, the manifold is solid and the second heat transfer medium is communicated across an outer surface of the manifold.

In a further non-limiting embodiment of any of the foregoing battery modules, a second heat pipe is attached to an opposite side of the plate from the heat pipe.

In a further non-limiting embodiment of any of the foregoing battery modules, a second manifold is connected to the second heat pipe.

In a further non-limiting embodiment of any of the foregoing battery modules, the first heat transfer medium is a liquid.

In a further non-limiting embodiment of any of the foregoing battery modules, the second heat transfer medium is one of air and a liquid.

In a further non-limiting embodiment of any of the foregoing battery modules, the heat pipe includes a heat absorbing portion and a heat dissipating portion.

In a further non-limiting embodiment of any of the foregoing battery modules, the heat dissipating portion includes a bulb.

In a further non-limiting embodiment of any of the foregoing battery modules, the heat absorbing portion is attached to the plate and the heat dissipating portion is received within a groove of the manifold.

An electrified vehicle according to an exemplary aspect of the present disclosure includes, among other things, a battery module having at least one battery cell. A battery thermal management system is configured to heat the at least one battery cell in response to a first temperature condition and cool the at least one battery cell in response to a second temperature condition.

In a further non-limiting embodiment of the foregoing electrified vehicle, the battery thermal management system includes a plate adjacent to the at least one battery cell, a heat pipe attached to the plate and containing a first heat transfer medium and a manifold connected to the heat pipe. A second heat transfer medium is communicated relative to the manifold to exchange heat with the first heat transfer medium.

In a further non-limiting embodiment of either of the foregoing electrified vehicles, the battery thermal management system includes a heat exchanger configured to alter a temperature of the second heat transfer medium.

In a further non-limiting embodiment of any of the foregoing electrified vehicles, the heat exchanger is disposed downstream from an outlet of the manifold.

In a further non-limiting embodiment of any of the foregoing electrified vehicles, the battery thermal management system includes a heater configured to add heat to the second heat transfer medium.

A method according to another exemplary aspect of the present disclosure includes, among other things, absorbing heat from a battery cell into a plate, conducting the heat from the plate to a heat pipe and dissipating the heat into a heat transfer medium communicated relative to the heat pipe to thermally manage the battery cell.

In a further non-limiting embodiment of the foregoing method, the heat pipe is located remotely from the battery cell.

In a further non-limiting embodiment of either of the foregoing methods, a temperature of the heat transfer medium is increased to heat the battery cell.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery module of an electrified vehicle.

FIG. 3 illustrates a front view of a battery module.

FIG. 4 illustrates another exemplary battery module.

FIG. 5 illustrates yet another battery module that includes a battery thermal management system.

### DETAILED DESCRIPTION

This disclosure relates to a battery module for use in an electrified vehicle. Among other features, the battery module of this disclosure includes a battery thermal management system capable of thermally managing the battery cells of the battery module. The exemplary battery module and methods described herein may be utilized to heat and/or cool the battery cells without the use of relatively expensive refrigerant chillers, valves, solenoids or other parts and irrespective of whether the electrified vehicle is being operated or not.

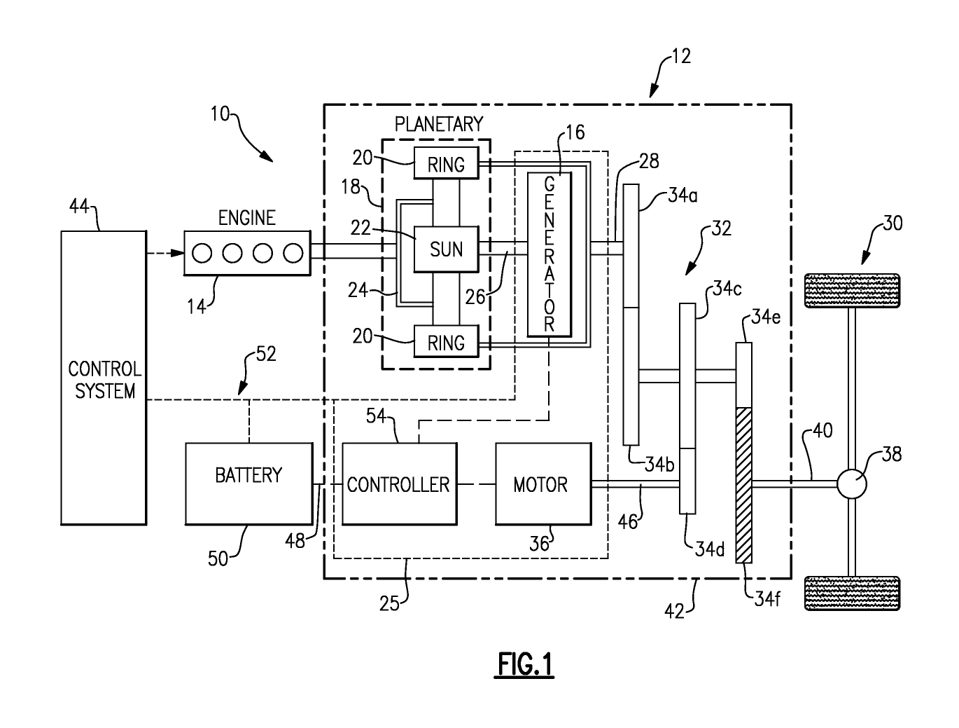

FIG. 1 schematically illustrates a powertrain 10 for an electrified vehicle 12, such as a hybrid electric vehicle (HEV). Although depicted as a HEV, it should be understood that the concepts described herein are not limited to HEV's and could extend to other electrified vehicles, including but not limited to, plug-in hybrid electric vehicles (PHEV's) and battery electric vehicles (BEV's).

In one embodiment, the powertrain 10 is a powersplit powertrain system that employs a first drive system that includes a combination of an engine 14 and a generator 16 (i.e., a first electric machine) and a second drive system that includes at least a motor 36 (i.e., a second electric machine), the generator 16 and a battery 50. For example, the motor 36, the generator 16 and the battery 50 may make up an electric drive system 25 of the powertrain 10. The first and second drive systems generate torque to drive one or more sets of vehicle drive wheels 30 of the electrified vehicle 12, as discussed in greater detail below.

The engine 14, such as an internal combustion engine, and the generator 16 may be connected through a power transfer unit 18. In one non-limiting embodiment, the power transfer unit 18 is a planetary gear set. Of course, other types of power transfer units, including other gear sets and transmissions, may be used to connect the engine 14 to the generator 16. The power transfer unit 18 may include a ring gear 20, a sun gear 22 and a carrier assembly 24. The generator 16 is driven by the power transfer unit 18 when acting as a generator to convert kinetic energy to electrical energy. The generator 16 can alternatively function as a motor to convert electrical energy into kinetic energy, thereby outputting torque to a shaft 26 connected to the carrier assembly 24 of the power transfer unit 18. Because the generator 16 is operatively connected to the engine 14, the speed of the engine 14 can be controlled by the generator 16.

The ring gear 20 of the power transfer unit 18 may be connected to a shaft 28 that is connected to vehicle drive wheels 30 through a second power transfer unit 32. The second power transfer unit 32 may include a gear set having a plurality of gears 34A, 34B, 34C, 34D, 34E, and 34F. Other power transfer units may also be suitable. The gears 34A-34F transfer torque from the engine 14 to a differential 38 to provide traction to the vehicle drive wheels 30. The differential 38 may include a plurality of gears that enable the transfer of torque to the vehicle drive wheels 30. The second power transfer unit 32 is mechanically coupled to an axle 40 through the differential 38 to distribute torque to the vehicle drive wheels 30.

The motor 36 can also be employed to drive the vehicle drive wheels 30 by outputting torque to a shaft 46 that is also connected to the second power transfer unit 32. In one embodiment, the motor 36 and the generator 16 are part of a regenerative braking system in which both the motor 36 and the generator 16 can be employed as motors to output torque. For example, the motor 36 and the generator 16 can each output electrical power to a high voltage bus 48 and the battery 50. The battery 50 may be a high voltage battery that is capable of outputting electrical power to operate the motor 36 and the generator 16. Other types of energy storage devices and/or output devices can also be incorporated for use with the electrified vehicle 12.

The motor 36, the generator 16, the power transfer unit 18, and the power transfer unit 32 may generally be referred to a transaxle 42, or transmission, of the electrified vehicle 12. Thus, when a driver selects a particular shift position, the transaxle 42 is appropriately controlled to provide the corresponding gear for advancing the electrified vehicle 12 by providing traction to the vehicle drive wheels 30.

The powertrain 10 may additionally include a control system 44 for monitoring and/or controlling various aspects of the electrified vehicle 12. For example, the control system 44 may communicate with the electric drive system 25, the power transfer units 18, 32 or other components to monitor and/or control the electrified vehicle 12. The control system 44 includes electronics and/or software to perform the necessary control functions for operating the electrified vehicle 12. In one embodiment, the control system 44 is a combination vehicle system controller and powertrain control module (VSC/PCM). Although it is shown as a single hardware device, the control system 44 may include multiple controllers in the form of multiple hardware devices, or multiple software controllers within one or more hardware devices.

A controller area network (CAN) 52 allows the control system 44 to communicate with the transaxle 42. For example, the control system 44 may receive signals from the transaxle 42 to indicate whether a transition between shift positions is occurring. The control system 44 may also communicate with a battery control module of the battery 50, or other control devices.

Additionally, the electric drive system 25 may include one or more controllers 54, such as an inverter system controller (ISC). The controller 54 is configured to control specific components within the transaxle 42, such as the generator 16 and/or the motor 36, such as for supporting bidirectional power flow. In one embodiment, the controller 54 is an inverter system controller combined with a variable voltage converter (ISC/VVC).

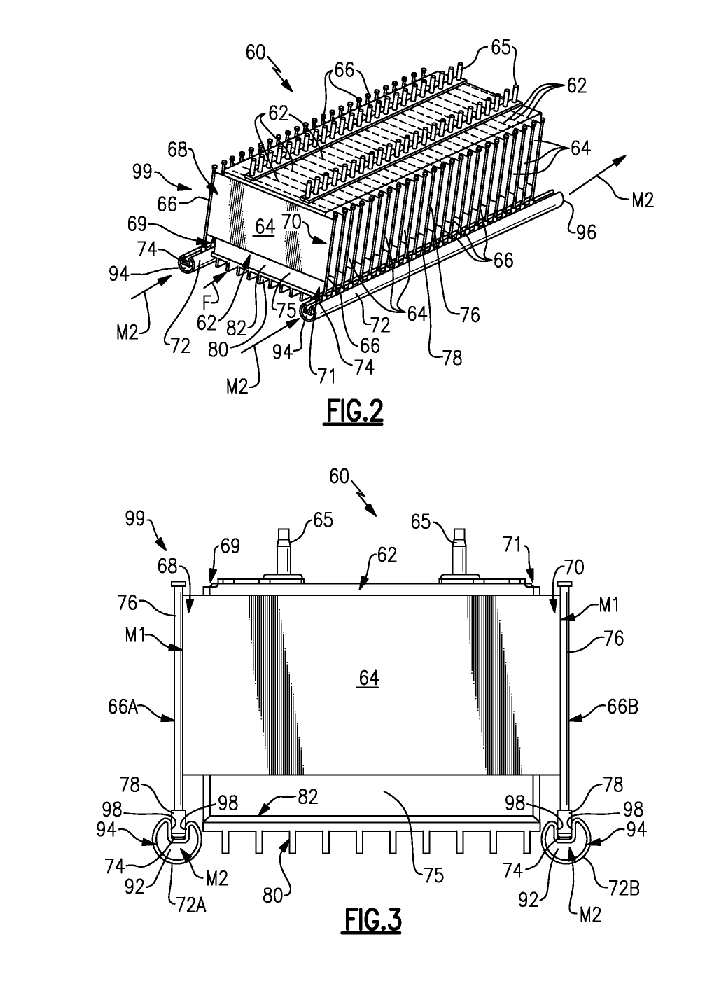

FIGS. 2 and 3 illustrate an exemplary battery module 60 that can be incorporated into an electrified vehicle. For example, the battery module 60 may be employed within the battery 50 of the electrified vehicle 12 of FIG. 1. The battery 50 could include any number of battery modules 60 for supplying electrical power to the electric machines 16, 36 of the electrified vehicle 12 (see FIG. 1).

One or more battery cells 62 may be stacked relative to one another to construct the battery module 60. Although not shown, a retention feature may be utilized to hold the battery cells 62 together. Each battery cell 62 includes two electrodes 65 that project outwardly from the battery cell 62. Heat may be generated inside each battery cell 62 during charging and discharging operations that occur during operation of the electrified vehicle 12 or when the electrified vehicle 12 is not being operated as a result of relatively extreme (i.e., hot or cold) ambient conditions.

The battery module 60 includes a battery thermal management system 99 for thermally managing the heat generated in the battery cells 62. In one embodiment, the battery thermal management system 99 includes one or more plates 64, heat pipes 66 and manifolds 72. As discussed in greater detail below, heat generated inside the battery cells 62 may be absorbed by the plates 64, conducted through the heat pipes 66, and then dissipated out of the battery module 60 via a heat transfer medium communicated through or across the manifolds 72. The battery thermal management system 99 may additionally include a fin structure 80 for removing additional heat from the battery cell(s) 62.

The plates 64 are positioned adjacent to each battery cell 62. The plates 64 may be received against a face 75 of each battery cell 62. The plates 64 are fixedly attached to the battery cells 62 in any known manner. In one embodiment, the battery module 60 includes a plurality of battery cells 62 and a plurality of plates 64, with at least one plate 64 interspersed between adjacent battery cells 62 to construct the battery module (best illustrated in FIG. 2).

The plates 64 may embody a size and shape that is different from a corresponding size and shape of the battery cells 62. For example, in one embodiment, the plates 64 include a smaller height than the height of the battery cells 62 and opposing sides 68, 70 of the plates 64 extend beyond opposing sides 69, 71 of the battery cells 62. However, the number, size and shape of the battery cells 62 and the plates 64 are not intended to limit this disclosure.

Each plate 64 may be constructed from a thermally conductive material. Non-limiting examples of thermally conductive materials that are suitable for the plates 64 include aluminum, copper, plastic, or any other thermally conductive material.

At least one heat pipe 66 is attached to each plate 64. The heat pipes 66 may be connected to the plates 64 in any known manner, such as by soldering, brazing, thermal grease or any other manner. In one embodiment, the heat pipes 66 are isolated from (i.e., do not contact) the battery cells 62 by virtue of their attachment to the opposing sides 68, 70 of the plates 64.

Each heat pipe 66 may include a heat absorbing portion 76 (i.e., the evaporation portion) and a heat dissipating portion 78 (i.e., the condenser portion). The heat absorbing portion 76 absorbs heat from the plate 64 it is attached to and the heat dissipating portion 78 emits the heat absorbed by the heat absorbing portion 76. In one embodiment, the heat dissipating portion 78 is a bulb that is attached to an end of the heat absorbing portion 76. However, the heat dissipating portion 78 may embody other designs and configurations.

The heat pipes 66 contain a first heat transfer medium M1 (schematically shown in FIG. 3) that can be vaporized inside the heat absorbing portion 76 and subsequently condensed in the heat dissipating portion 78, as is further discussed below. The heat pipes 66 may be of the capillary force type, gravity type, or any other known type. Non-limiting examples of substances that may be utilized as the first heat transfer medium M1 include refrigerant, liquid ammonia, methanol or water.

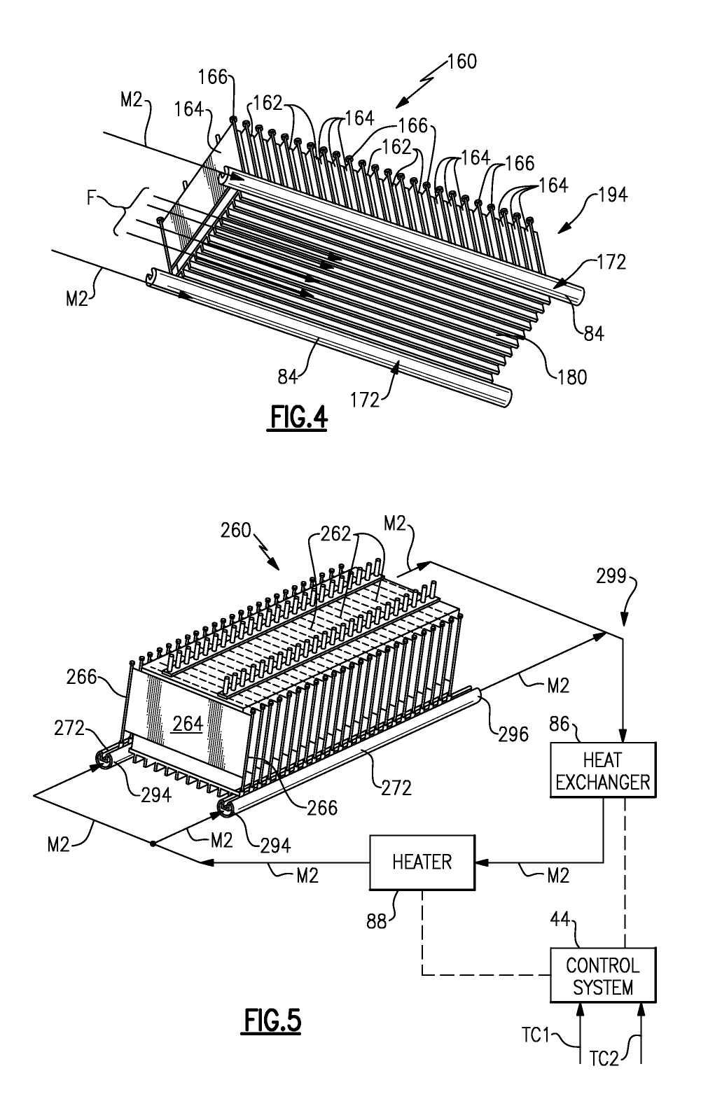

Each heat pipe 66 is connected to the manifold 72. In one embodiment, the manifold 72 include a groove 74 that receives the heat dissipating portions 78, or bulbs, of the heat pipes 66. The manifold 72 may be either hollow (see FIGS. 2 and 3) or solid (see FIG. 4). In the hollow embodiment of FIGS. 2 and 3, the manifold 72 includes a hollow opening 92 that extends through the length of the manifold 72 between an inlet 94 and an outlet 96. A second heat transfer medium M2 may be communicated inside of the manifold 72 through the hollow opening 92 to either add or remove heat from the heat dissipating portions 78 of the heat pipes 66. In other words, the second heat transfer medium M2 exchanges heat with the first heat transfer medium M1. Non-limiting examples of substances that may be utilized as the second heat transfer medium M2 include air, coolant, or other liquids and substances. In one embodiment, the first and second heat transfer mediums M1, M2 are different substances.

In one embodiment, the fin structure 80 of the battery thermal management system 99 is attached to a bottom 82 of the battery cell(s) 62. The fin structure 80 is a cold plate for air cooling the battery cell(s) 62. The fin structure 80 removes additional heat from the battery cell(s) 62 as airflow F is communicated across the fin structure 80.

The battery thermal management system 99 detailed above may be used to thermally manage the battery cells 62 of the battery module 60. The battery thermal management system 99 is operable to cool the battery cells 62 during operation or non-operation (i.e., vehicle off conditions) of the electrified vehicle. For example, ambient airflow F that flows across the battery module 60 during non-operating conditions of the electrified vehicle may be used as the second heat transfer medium M2 for exchanging heat with the first heat transfer medium M1.

In one non-limiting use of the battery thermal management system 99, heat generated in the one or more battery cells 62 is absorbed by the plates 64. The heat pipes 66 conduct the heat from the plates 64 by conducting the heat into the heat absorbing portions 76. As this occurs, the first heat transfer medium M1 of each heat pipe 66 is vaporized into a vapor flow. The vapor flow accumulates in the heat dissipating portions 78 of the heat pipes 66, which contact the manifolds 72. The second heat transfer medium M2 is communicated either across an outer surface (see FIG. 4) or inside of the manifolds 72 and exchanges heat with the first heat transfer medium M1. The heat generated in each battery cell 62 is dissipated from the battery module 60 through the second heat transfer medium M2, which is expelled from the outlets 96 of the manifolds 72.

FIG. 3 illustrates one exemplary layout of the heat pipes 66 of the battery thermal management system 99. In this embodiment, a first heat pipe 66A is positioned on the first side 68 of the plate 64, and the second heat pipe 66B is positioned on the second side 70 of the plate 64. The heat pipes 66A, 66B may be connected to the plate 64 in any known manner. The heat pipes 66A, 66B are isolated from, and not in contact with, the battery cell 62 because they are attached to the sides 68, 70 of the plates 64, which extend beyond the sides 69, 71 of the battery cells 62.

The heat pipes 66A, 66B are connected to separate manifolds 72A, 72B, respectively, such that heat can be dissipated from both sides 68, 70 of the plate 64. In one embodiment, the heat pipes 66A, 66B are received in grooves 74 of the manifolds 72A, 72B such that the heat dissipating portions 78 of the heat pipes 66A, 66B are substantially surrounded by surfaces 98 of the manifolds 72A, 72B.

FIG. 4 illustrates another exemplary battery module 160. In this disclosure, like reference numbers designate like elements where appropriate and reference numerals with the addition of 100 or multiples thereof designate modified elements that are understood to incorporate the same features and benefits of the corresponding original elements.

In this embodiment, the manifolds 172 of a battery thermal management system 199 are solid structures rather than the hollow design depicted in FIGS. 2 and 3. In other words, the second heat transfer medium M2 is communicated across an outer surface 84 of each manifold 172, rather than through a hollow opening, in order to exchange heat with the first heat transfer medium M1 (see FIG. 3) that is contained inside the heat pipes 166. In one embodiment, the second heat transfer Medium M2 is supplied by an air stream F, which could also flow across the fin structure 180 of the battery thermal management system 199 to cool one or more battery cells 162 of the battery module 160.

FIG. 5 illustrates yet another battery module 260. The battery module 260 includes a thermal management system 299 for thermally managing the battery cells 262 of the battery module 260. In this embodiment, the battery thermal management system 299 may be employed to either add or remove heat from battery cells 262 of the battery module 260.

In addition to plates 264, heat pipes 266 and manifolds 272, the exemplary battery thermal management system 299 may incorporate a heat exchanger 86. The heat exchanger 86 is positioned downstream from the outlets 296 of the manifolds 272. The second heat transfer medium M2 is communicated to the heat exchanger 86 after it has exchanged heat with the first heat transfer medium M1 (not shown). The heat exchanger 86 conditions the second heat transfer medium M2 before communicating it back to the battery module 260 through the inlets 294 of the manifolds 272. For example, the heat exchanger 86 may cool the second heat transfer medium M2 to remove the heat that was dissipated from the battery cells 262 before returning the second heat transfer medium M2 to the manifolds 272 to remove additional heat from the battery module 260. In other words, the second heat transfer medium M2 can be communicated in a closed-loop, recirculation system. In one non-limiting embodiment, the heat exchanger 86 is a radiator.

A heater 88 may additionally be incorporated into the battery thermal management system 299 in order to heat the battery module 260. The heater 88 is positioned downstream from the heat exchanger 86, in one embodiment. The heater 88 adds heat to the second heat transfer medium M2 prior to returning the second heat transfer medium M2 to the manifolds 272.

In one non-limiting use, the battery thermal management system 299 can heat the battery cells 262 in response to a first temperature condition TC1 (i.e., relatively cold ambient temperatures) and cool the battery cells 262 in response to a second temperature condition TC2 (i.e., relatively hot ambient temperatures). The first and second temperature conditions TC1 and TC2 can be sensed by the control system 44 (see also FIG. 1), which may be in communication with the thermal management system 299. The control system 44 may turn the heater 88 on in response to sensing the first temperature condition TC1. The heater 88 heats the second heat transfer medium M2 before it is returned to the manifolds 272. The second heat transfer medium M2 may then heat the heat pipes 266, which subsequently add heat to the plates 264 and then to the battery cells 262. The battery cells 262 may need heated during non-operation of the electrified vehicle, such as during the winter months of colder climates.

The heater 88 is commanded off in response to sensing a second temperature condition TC2. The heat exchanger 86 may be used to cool the second heat transfer medium M2 in response to sensing the second temperature condition TC2. The cooled second heat transfer medium M2 may then be returned to the manifolds 272 for exchanging heat with another heat transfer medium contained inside the heat pipes 266 to cool the battery cells 262. The battery cells 262 may need cooled during relatively hot ambient temperatures, such as during summer months or in warmer climates.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery module, comprising:
a battery cell;
a plate adjacent to said battery cell;
a heat pipe attached to said plate and containing a first heat transfer medium; and
a manifold connected to said heat pipe and configured to receive a second heat transfer medium that exchanges heat with said first heat transfer medium.

2. The battery module as recited in claim 1, comprising a fin structure attached to a bottom of said battery cell.

3. The battery module as recited in claim 1, comprising a plurality of battery cells and a plurality of plates, at least one of said plurality of plates interspersed between adjacent battery cells of said plurality of battery cells.

4. The battery module as recited in claim 1, wherein said manifold is hollow and said second heat transfer medium is communicated inside a hollow opening of said manifold.

5. The battery module as recited in claim 1, wherein said manifold is solid and said second heat transfer medium is communicated across an outer surface of said manifold.

6. The battery module as recited in claim 1, comprising a second heat pipe attached to an opposite side of said plate from said heat pipe.

7. The battery module as recited in claim 6, comprising a second manifold connected to said second heat pipe.

8. The battery module as recited in claim 1, wherein said first heat transfer medium is a liquid.

9. The battery module as recited in claim 1, wherein said second heat transfer medium is one of air and a liquid.

10. The battery module as recited in claim 1, wherein said heat pipe includes a heat absorbing portion and a heat dissipating portion.

11. The battery module as recited in claim 10, wherein said heat dissipating portion includes a bulb.

12. The battery module as recited in claim 10, wherein said heat absorbing portion is attached to said plate and said heat dissipating portion is received within a groove of said manifold.

13. An electrified vehicle, comprising:
a battery module having at least one battery cell; and
a battery thermal management system configured to heat said at least one battery cell in response to a first temperature condition and cool said at least one battery cell in response to a second temperature condition.

14. The electrified vehicle as recited in claim 13, wherein said battery thermal management system includes:
a plate adjacent to said at least one battery cell;
a heat pipe attached to said plate and containing a first heat transfer medium;
a manifold connected to said heat pipe, and
wherein a second heat transfer medium is communicated relative to said manifold to exchange heat with said first heat transfer medium.

15. The electrified vehicle as recited in claim 14, wherein said battery thermal management system include a heat exchanger configured to alter a temperature of said second heat transfer medium.

16. The electrified vehicle as recited in claim 15, wherein said heat exchanger is disposed downstream from an outlet of said manifold.

17. The electrified vehicle as recited in claim 14, wherein said battery thermal management system includes a heater configured to add heat to said second heat transfer medium.

18. A method, comprising:
absorbing heat from a battery cell into a plate;
conducting the heat from the plate to a heat pipe; and
dissipating the heat into a heat transfer medium communicated relative to the heat pipe to thermally manage the battery cell.

19. The method as recited in claim 18, wherein the heat pipe is located remotely from the battery cell.

20. The method as recited in claim 18, comprising the steps of:
increasing a temperature of the heat transfer medium; and
heating the battery cell in response to the step of increasing.
